(19) United States
(12) Patent Application Publication
(10) Pub. No.: US 2020/0229363 A1
(43) Pub. Date: Jul. 23, 2020

(54) Seeding Tray and Method of Use

(71) Applicant: Just Greens, LLC, Newark, NJ (US)

(72) Inventor: Elaine Kung, Brooklyn, NY (US)

(73) Assignee: Just Greens, LLC, Newark, NJ (US)

(21) Appl. No.: 16/744,838

(22) Filed: Jan. 16, 2020

Related U.S. Application Data
(60) Provisional application No. 62/795,303, filed on Jan. 22, 2019.

(51) Int. Cl. A01G 31/06; A01G 9/029; A01C 1/02

(52) U.S. Cl. CPC A01G 31/06; A01C 1/02; A01G 9/0293

(57) ABSTRACT

Versions of the disclosure relate to multilayer structures for germinating seeds and growing plants in aeroponic or hydroponic farming. The multilayer structure can include a growth medium positioned in close proximity to a seeding tray. The seeding tray may be configured and dimensioned to at least partially retain a germinating seed. Optional grid tray may be positioned below the growth medium and configured and dimensioned to support the growth medium.

### CROSS-REFERENCE TO RELATED APPLICATION

The present application claims priority benefit to a provisional patent application entitled “Seeding Tray and Method of Use,” which was filed on Jan. 22, 2019, and assigned Ser. No. 62/795,303. The entire content of the foregoing provisional application is incorporated herein by reference.

### TECHNICAL FIELD

Embodiments of the disclosure relate to soilless multilayer seed germination and plant development media useful in aeroponic and hydroponic farming.

### BACKGROUND

Aeroponic farming involves spraying a liquid nutrient solution on the roots of developing plants. Roots of these plants are generally bare and suspended in a growth chamber where the nutrients are sprayed. In some versions of aeroponic farming, seeds are deposited on the top surface of a cloth that may be supported by a frame. The seeds are germinated and then the cloth on the frame is placed in the growth chamber. In the growth chamber, the upper side of the cloth is subjected to light of proper wavelength and intensity to promote growth in developing the plants, and the underside of the cloth and the developing root mass is subjected to a nutrient solution. The plants resulting from the seeds are harvested at a desired stage of growth. The growth chambers may be stacked on each other and/or located side-by-side to save space within a facility and to permit sharing of the subsystems, which provide the nutrient solution, temperature, humidity, and carbon dioxide to the growth chambers. A rapidly developing and healthy plant canopy is beneficial in these systems because it reduces the amount of light that reaches the cloth medium and may reduce the formation of harmful algae growth.

Cloth materials have been used as germination and growing substrates or media in aeroponic farming. Algae formation may occur on the relatively high surface area of the cloth fibers in the presence of moisture laden with nutrients and light used to germinate the seeds and grow the plants. Algae growth competes with germinating seeds and growing plants for nutrients, light, and moisture. The presence of algae on these growth substrates is esthetically undesirable and makes cleaning of the growth substrates between uses more difficult and costly. The presence of algae on the growth substrate may also result in plugging of the substrate and interference with the aeroponic spray and air flow. Algae formation may also occur on the nozzles and the underlying drainage trays which needs to be removed by cleaning and filtration to prevent the spread of the algae into other parts of the growing system. The added cleaning, the expense of filters, and the associated growth tower downtime for filter changeouts and hardware cleaning are costly.

Algae growth and plant rot are more common on low spots of the growth substrate where excess moisture and seeds accumulate and contact each other.

Evaporation of water from the cloth used in some aeroponic farming can lead to increased costs required for air conditioning of the indoor farm and excess water use.

Thus, a need exists for improved growing media and substrates that may be used in aeroponic farming, that improve, for example, harvest yields, reduce algae growth, reduce costs associate with cleaning and automatic seeding, and reduce evaporation of water.

### SUMMARY

Algae growth on growth media used in aeroponic or hydroponic farming may be reduced or eliminated by a multilayer article adapted for germinating seeds and growing plants that includes a seeding tray that has one or more openings (e.g., cavities). The one or more cavities pass through the seeding tray and are configured and dimensioned to accommodate one or more seeds. The un-opened portions of the seeding tray may have a light transmittance, measured by intensity, that is 50% or less than the amount of the light transmittance through any opening in the seeding tray. In some embodiments of the disclosure, the seeding tray may include a fluorescent material. In some embodiments, the seeding tray may include a fluorescent material that converts a portion or all of the light that is incident on surfaces of the article, for example surfaces that are not those of the plants, and converts this light to a longer wavelength light of which a portion can be re-directed to the germinating seeds and or developing plants.

The disclosed seeding tray may be positioned in close proximity to and separable from a soilless growth medium (e.g., cloth or fabric). The soilless growth medium is adapted for seed germination, penetration of roots from developing plants through the medium, and prevents the direct passage of nutrient mist or fog droplets through the medium. In some embodiments, sprayers may be positioned below the growth medium and provide water-based, nutrient-based, or water- and nutrient-based mist or fog to interact with the roots. In other embodiments, a container with a water-based, a nutrient-based, or a water- and nutrient-based solution may be used to periodically contact the roots. In other embodiments, a container with a water-based, a nutrient-based, or a water- and nutrient-based solution may be used to maintain contact with the roots.

Advantages of embodiments of the disclosure include a more uniform growing pattern on the growth medium since seeds will not move over the cloth after seeding because the seeds are at least partially captured or retained in the cavities of the seeding tray. Minimizing or eliminating penetration of light onto the growth medium, by the closed portions of the seeding tray, will reduce heating of the nutrient solution, reduce evaporation from the growth medium, and reduce algae growth on the growth medium, the nozzles, and inside any drip pans. Having a seeding tray may also decrease evaporation from the growth medium thereby reducing air conditioning and water use compared to uncovered growth media. Minimizing or eliminating evaporation from the growth medium may also reduce the potential for plant rot.

The embodiments disclosed herein meets these and other needs by providing a system and method for containing and redirecting plant growth, and reducing light penetration onto the growth medium.

### BRIEF DESCRIPTION OF THE DRAWINGS

FIG. 1A schematically depicts a side view of an advantageous seeding tray and soilless growth medium according to the present disclosure;

FIG. 1B schematically depicts a side view of an advantageous seeding tray and soilless growth medium according to the present disclosure;

FIG. 2 schematically depicts a top view of an advantageous seeding tray according to the present disclosure;

FIG. 3 illustrates plant growth extending from an advantageous seeding tray and soilless growth medium according to the present disclosure;

FIG. 4 schematically depicts a side view of an advantageous seeding tray, soilless growth medium and grid tray according to the present disclosure; and

FIG. 5 schematically depicts a perspective view of an advantageous grid tray according to the present disclosure.

### DETAILED DESCRIPTION

In the following description, it is understood that terms such as “top,” “bottom,” “outward,” “inward,” and the like are words of convenience and are not to be construed as limiting terms. Reference will now be made in detail to exemplary embodiments of the disclosure, which are illustrated in the accompanying figures and examples. Referring to the drawings in general, it will be understood that the illustrations are for the purpose of describing particular embodiments of the disclosure and are not intended to limit the same.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

The noted disadvantages of the disclosed soilless growth medium used in aeroponic or hydroponic farming (e.g., high rate of water evaporation and algae growth) may be reduced or eliminated by the disclosed seeding tray. The disclosed seeding tray may be positioned in close proximity to soilless growth medium (e.g., cloth). The disclosed seeding tray may include a plurality of cavities. The plurality of cavities may be configured and dimensioned to accept at least one seed. The disclosed seeding tray may be configured to enable root growth to at least partially interact with the soilless growth medium. The plurality of cavities may be positioned in close proximity to one another so as to maximize the space defined by the disclosed seeding tray. However, the distance between the plurality of cavities may be configured to optimize plant/seed growth. Therefore, the distance between the plurality of cavities may be different depending on the variety of seed/plant and growing conditions, among other parameters. In some embodiments, the plurality of cavities may be spaced about 0.1 centimeter to about 10 centimeter apart, which further defines a spacing range of about 0.5 centimeter to about 2 centimeter. In some embodiments, the plurality of cavities may be positioned about one centimeter apart. The plurality of cavities may be positioned about one centimeter apart on-center. The disclosed seeding tray may be fabricated from a polymer (e.g., silicone, polypropylene, moldable plastic, and any combination thereof).

Referring now to the drawings, like parts are marked throughout the specification and drawings with the same reference numerals, respectively. Drawing figures are not necessarily to scale and in certain views, parts may have been exaggerated for purposes of clarity.

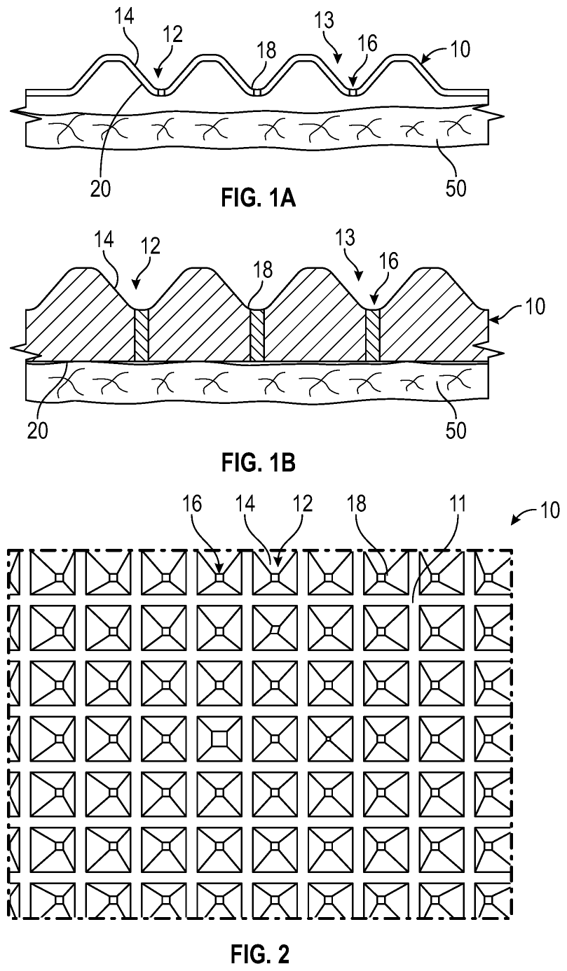

FIGS. 1A and 1B depict seeding tray 10 and soilless growth medium 50. Seeding tray 10 may be positioned in close proximity to soilless growth medium 50. Seeding tray 10 may be positioned at least partially in contact with and above soilless growth medium 50. Seeding tray 10 may be positioned a distance away from and above soilless growth medium 50. Seeding tray 10 may include a plurality of cavities 12. The plurality of cavities 12 may be positioned in a pattern, for example but not limited to a grid-based pattern, encompassing at least one surface of seeding tray 10. In some embodiments, the plurality of cavities 12 may be positioned such that cavity opening 13 is furthest away from soilless growth medium 50, as depicted in FIGS. 1A and 1B. The plurality of cavities 12 are at least partially defined by sidewall 14. The plurality of cavities 12 may be at least partially defined by sidewalls 14 and base 18. The plurality of cavities 12, at least partially defined by sidewalls 14 and base 18, may be defined as cubical, cylindrical, conical, frustoconical, and any combination thereof. The plurality of cavities 12 may have a cross-section that is quadrilateral, triangular, circular and any combination thereof. The plurality of cavities 12 may be similar or may be dissimilar such that seeding tray 10 may include cavities 12 having at least two different cross-sectional or three-dimensional shapes. The plurality of cavities 12 may further include seed hole 16, which is positioned a distance between base 18 and seeding tray bottom 20. Seed hole 16 may be positioned opposite cavity opening 13. In some embodiments, seed hole 16 may be positioned such that a substantial portion of base 18 is occupied. Seed hole 16 may be a through hole that extends between base 18 and seeding tray bottom 20. Seed hole 16 may facilitate at least partial pass-through of at least one of the germinating seed or the root growth.

As depicted in FIGS. 1A and 1B, seeding tray 10 may be fabricated in a variety of configurations. For example, in some instances, seeding tray 10 may have a cross-section that is substantially sinusoidal, as depicted in FIG. 1A. In other instances, seeding tray 10 may have a cross-section that is partially sinusoidal and further defines a substantially planar bottom 20, as depicted in FIG. 1B. In another embodiment, seeding tray 10 may have a cross-section that at least partially replicates a sinusoidal curve, a square wave, a triangle wave, a frustoconical wave and any combination thereof. The thickness of seeding tray 10 may vary depending on the application. The thickness of seeding tray 10, as particularly defined by the distance between base 18 of cavity 12 and seeding tray bottom 20, may vary depending on the application. For example, the thickness of seeding tray 10, depicted in FIG. 1B, may be thicker than the thickness of seeding tray 10, depicted in FIG. 1A. However, any combination of thickness and cross-sectional configurations (e.g., at least partial of a sinusoidal curve, a square wave, a triangular wave, and a frustoconical wave) is anticipated. A thicker cross section may be advantageous for some growth media where root penetration through the media is difficult because it restrict roots from spreading below the base surface along the top of the media rather than penetrating the media.

FIG. 2 depicts a top view of a portion of seeding tray 10. A plurality of frustoconical cavities 12 are positioned in a grid-based configuration. The plurality of frustoconical cavities 12 may extend downwardly from top surface 11. The plurality of frustoconical cavities 12 may be at least partially defined by sidewalls 14 and base 18. The plurality of frustoconical cavities 12 may further include seed hole 16 which is at least partially positioned on base 18. Seed hole 16 may be substantially perpendicular to base 18. In some embodiments, seed hole 16 may define a substantial area of base 18. Seed hole 16 may be circular, quadrilateral, triangular, and any combination thereof. Seed hole 16 may extend at least partially between base 18 and seeding tray bottom (not shown). Seed hole 16 may be a through hole that extends through base 18 and seeding tray bottom (not shown). Seed hole 16 may be configured and dimensioned to at least partially interact with at least one root or stem from a germinating seed or developing plant. Frustoconical cavity 12 may be positioned a predetermined distance from adjacent frustoconical cavities 12. In some embodiments, the plurality of cavities 12 may be spaced about 0.1 centimeter to about 10 centimeter apart, which further defines a spacing range of about 0.5 centimeter to about 2 centimeter. In some embodiments, the plurality of cavities 12 may be positioned about one centimeter apart.

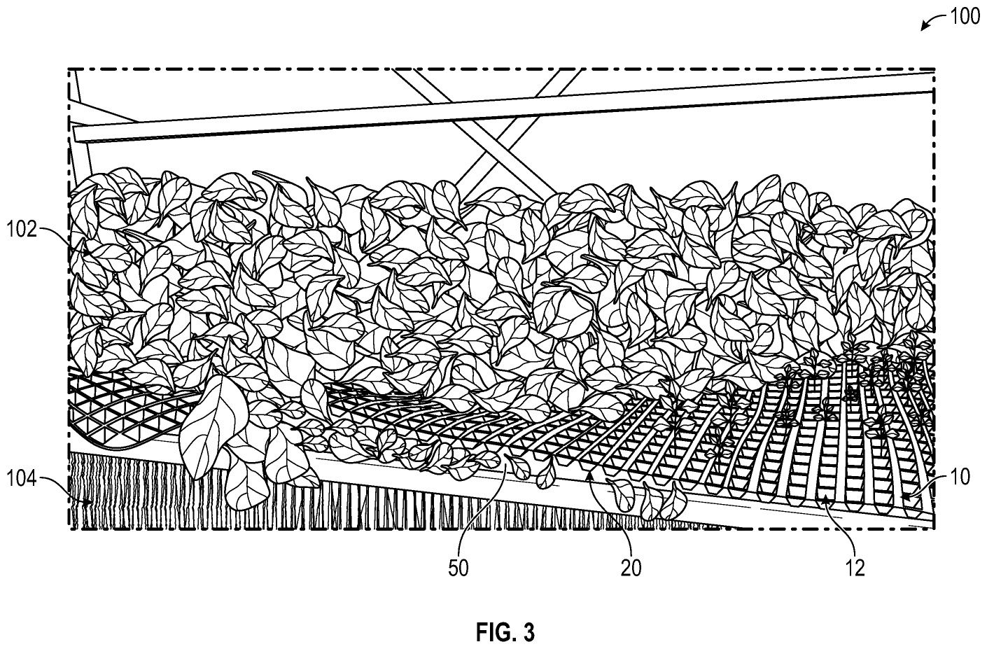

FIG. 3 depicts a plurality of plants positioned with respect to seeding tray 10. More particularly, a plurality of plants positioned with respect to a plurality of cavities 12 of seeding tray 10. As depicted, the plurality of cavities 12 may be frustoconical. Frustoconical cavities 12 may further include a plurality of seed holes (not shown). However, seeding tray 12 may include a variety of cavity configurations, including cylindrical, conical, cubical, frustoconical, and any combination thereof.

Positioned in close proximity to seeding tray 10 is soilless growth medium 50. Soilless growth medium 50 may be positioned in at least partial contact with seeding tray 10 and in close proximity to the plurality of seed holes (not shown). As mentioned above, at least one seed may be positioned within a corresponding seed hole (not shown) such that during growth, plant leaves/stem 102 extend opposite growth medium 50. Further, at least a portion of roots 104 may extend from the seed hole (not shown) to at least partially interact with soilless growth medium 50.

In some embodiments, the seed hole (not shown) may be configured and dimensioned to retain a portion of at least one seed. The seed hole (not shown) may be configured and dimensioned to retain a substantial portion of at least one seed. The depth of the seed hole (not shown) may be sufficient to encapsulate a substantial portion of the seed, regardless of the seed orientation. The diameter of the seed hole (not shown) may be dimensioned to partially interact with the seed. Configuring and dimensioning the seed hole (not shown) to retain a substantial portion of at least one seed may assist with ensuring minimal seed movement within the seed hole (not shown). The seed hole (not shown) may be configured and dimensioned to ensure a seed does not move (e.g., slide) and/or become positioned between seeding tray bottom 20 and soilless growth medium 50.

In some embodiments, seeding tray 10 may include a fluorescent material that converts a portion or all of the light that is incident on surfaces of seeding tray 10, for example surfaces that are not those of the seeds/plants, to a longer wavelength light of which a portion may be directed to the germinating seeds and or developing plants within the plurality of cavities 12. For example, sidewalls 14 of the plurality of cavities 12 may include a fluorescent material, as described above.

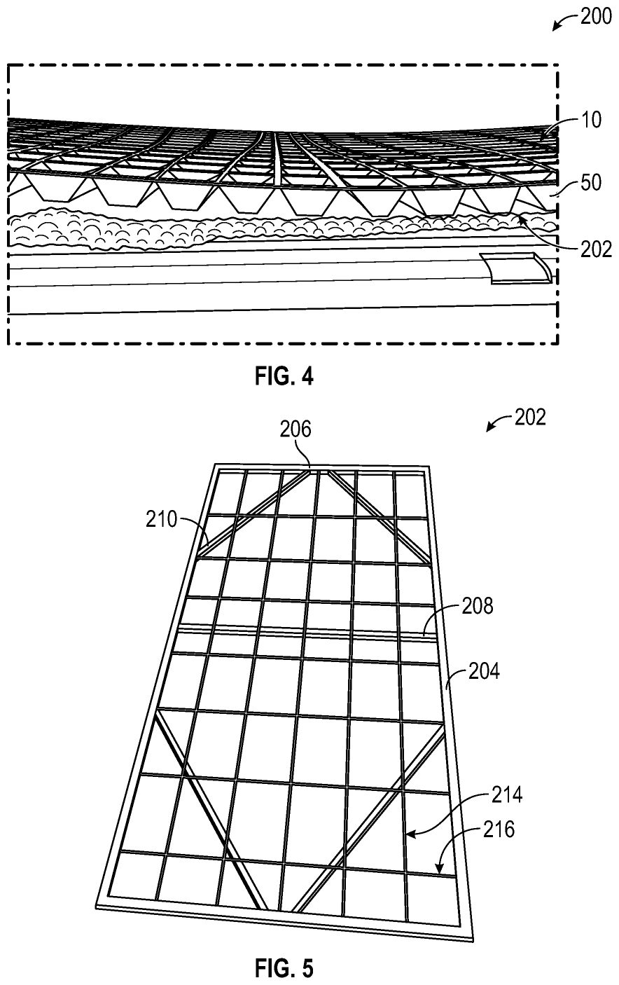

In some embodiments, seeding tray 10 and soilless growth medium 50 may be positioned in close proximity to grid tray 202. Seeding tray 10 may be positioned in close proximity to soilless growth medium 50, which may be positioned in close proximity to grid tray 202. For example, seeding tray 10 may be positioned in at least partial contact with soilless growth medium 50, which may be positioned in at least partial contact with grid tray 202, as depicted in FIG. 4. Grid tray 202 may assist in stabilizing/supporting soilless growth medium 50. Grid tray 202 may assist in maintaining soilless growth medium 50 in a substantially taunt configuration so as to ensure minimal puddling of water and/or nutrients. Soilless growth medium 50 may be semi-permanently positioned relative to grid tray 202. For example, grid tray 202 may include features to at least partially engage with soilless growth medium 50. In another example, soilless growth medium 50 and grid tray 202 may be at least partially engaged with at least one fastener.

Grid tray 202 may be configured and dimensioned to engage with at least one soilless growth medium 50. In some embodiments, grid tray 202 is configured and dimensioned to engage with one soilless growth medium 50. In other embodiments, grid tray 202 is configured and dimensioned to engage with at least two soilless growth mediums 50. Grid tray 202 may be configured in a variety of shapes, including, circular, triangular, quadrilateral, and any combination thereof. Grid tray 202 may be fabricated from a material that can withstand the weight of soilless growth medium 50, seeding tray 10 and optionally the weight of a plurality of plants. Grid tray 202 may be fabricated from metal, plastic, ceramic, silicone, and any combination thereof.

As depicted in FIG. 5, grid tray 202 may be defined as being substantially quadrilateral (e.g., square, rectangle). Grid tray 202 may be defined by first side 204 and second side 206. In this example, first side 204 may be at least partially longer than second side 206, however, additional variations are expected, without departing from the spirit/scope of this disclosure. Two first sides 204 and two second sides 206 may be positioned relative to each other to define the perimeter of grid tray 202. Two first sides 204 may be positioned substantially parallel to each other at a defined distance and two second sides 206 may be positioned substantially parallel to each other at a defined distance and may be substantially perpendicular to the two first sides 204. Optional first bar(s) 208 may be positioned a defined distance from first sides 204 or from second sides 206. Optional first bar(s) 208 may assist in strengthening grid tray 202. Optional first bar(s) 208 may be substantially parallel to first sides 204 or to second sides 206. Optional second bar(s) 210 may be positioned relative to both first side 204 and second side 206. Similar to optional first bar(s) 208, optional second bar(s) 210 may assist in strengthening grid tray 202. Optional second bar(s) 210 may be positioned diagonally between first side 204 and second side 206. Grid tray 202 may include four optional second bars 210, one positioned in each corner of grid tray 202.

Grid tray 202 may further include elements to support at least the interior portion of soilless growth medium 50. In some examples, grid tray 202 may include support elements 214, 216. Support elements 214, 216 may be configured and dimensioned to support at least one soilless growth medium 50 of various weight(s). Support elements 214, 216 may extend between first sides 204, second sides 206, and/or between first side 204 and second side 206. In some embodiments, support elements 214, 216 may extend between two first sides 204 and, additionally, between two second sides 206, thereby intersecting to form a lattice configuration. Soilless growth medium 50 may be at least partially in contact with support elements 214, 216.

### EXAMPLE 1

This example illustrates the germination and development of arugula from seeds on a soilless cloth medium using a seeding tray.

Baby arugula (102) was grown on a flat (100) using the seeding tray (10) as illustrated in FIG. 3. The seeding tray was position on top of a polyester based cloth soilless growth medium (50) that was held in place on a metal frame or grid tray below the cloth using fasteners. A flexible silicone baking sheet was used as the seeding tray and included 2 millimeter openings in the bottom of the cavities for the seeds. The flat was about 2.5 feet in width and about 5 feet in length.

The flat including the metal frame, cloth, and seeding tray was seeded with approximately 9 grams of Arugula and there was approximately one seed per cavity in the sheet for a majority of the tray. The seeds were germinated under the same conditions as test flats seeded with 9 grams of Arugula on the cloth and frame, but without the seeding tray.

After germination, the flats with the seeding tray and the control flats were placed in a growth chamber and the plants developed. After approximately 14 days of plant development under the same conditions including nutrients, light, and temperature, the flats were removed from the growth chamber. Developed plants were observed growing from the soilless cloth growth medium, through the plurality of cavity opening and above the cavities in the seeding tray (see FIG. 3). The developed plants had a thick healthy canopy and dense mass of roots.

The developed plants were harvested and the resulting yield compared to the control flats grown and harvested under similar conditions. The harvest yield from the test flat was 2.98 lbs which was higher than the yield from the control flats, which had a 95% confidence interval and ranged from 2.12 lbs to 2.58 lbs.

### EXAMPLE 2

This example illustrates the reduced evaporation rate of water from a test flat having a seeding tray with 2 millimeter holes in the bottom of the cavities which was positioned atop the cloth medium on a metal frame, as compared to the evaporation rate of water from a flat without the seeding tray and only the cloth on the frame, under the same test conditions.

The evaporation rate of water was measured comparing a control flat that included a polar fleece cloth, as disclosed in Harwood U.S. Pat. Pub. No. 2014/0137471, and a test flat that included the same polar fleece cloth and silicone seeding tray with 2 mm holes in the bottom of the cavities that was positioned atop the cloth. The test equipment included a 0 to 400 pound scale with data port that was positioned underneath the flats to measure changes in weight with time.

Air temperature, humidity and water temperature in the test apparatus were measured using sensors and data loggers used to record the sensor outputs. The control and test flats were similar in size and measured approximately (1.5 meters×0.75 meters; 5 foot×2.5 foot). The flats were placed on a pan that was interfaced with the scale. Fans and lights were installed on the test setup to simulate the evaporative environment in growth chambers. A 5 gallon reserve of water at room temperature (˜70 F, 21° C.) was used to soak the cloths. The scale was zeroed and the dry test medium on a tray and pan was placed into the evaporation testing set-up to obtain the dry weights.

The cloth for the control flat and test flats were similarly treated by submersion in the water and allowed to soak for one minute. The cloths were removed from the bucket and allowed to drip into the bucket to a similar state and then attached to the tray; a seeding tray with openings was placed overtop the wet cloth on the test flat. Zero the scale and place the tray into the test set up and center the tray in the pan. The pan was interfaced with the scale to measure the weight change of the fabric as water evaporated from it. Turn on the scale, the temperature and humidity data logger, LED light rack and the fans. Record weight, temperature, and humidity readings every 1 minute. After one hour shut down the test.

The evaporation testing showed that the rate of evaporation from the test flat (included the silicone seeding tray layer with openings and solid portions atop the cloth) was 72% less than the rate of evaporation from the control flat (no seeding tray). A lower evaporation rate from a flat is advantageous because it reduces water loss from the nutrient solution thereby improving plant growing process stability. Less water loss also reduces equipment and operational costs associated with dosing equipment, environmental humidity control, sensors, and chemical analysis to maintain the nutrient solution concentration.

The following clauses define particular aspects and embodiments of the disclosure.

Clause 1. An article adapted for germinating seeds and growing plants including:
a seeding tray having a first surface, a second surface, and sidewalls and further defining a plurality of cavities; and
a soilless growth medium positioned with respect to the seeding tray and separable therefrom, the soilless growth medium adapted for seed germination and penetration of roots from developing plants therethrough,
wherein the plurality of cavities are configured and dimensioned to at least partially retain at least one seed.

Clause 2. The article of clause 1, wherein the plurality of cavities are defined as cubical, cylindrical, conical, frustoconical, and any combination thereof.

Clause 3. The article of clause 1, wherein the plurality of cavities are positioned in a grid-based pattern.

Clause 4. The article as in any one of clauses 1-3, wherein the plurality of cavities are positioned about 0.5 centimeters to about 2 centimeters apart.

Clause 5. The article as in any one of clauses 1-4, wherein the cavity is defined by at least one sidewall and a base.

Clause 6. The article as in any one of clauses 1-5, wherein the cavity further defines a seed hole extending from the base through the second surface of the seeding tray.

Clause 7. The article of clause 6, wherein the seed hole is configured and dimensioned to at least partially retain at least one seed.

Clause 8. The article as in any one of clauses 1-7, wherein the seeding tray is fabricated from a polymer.

Clause 9. The article as in any one of clauses 1-8, wherein the soilless growth medium is positioned below the second surface of the seeding tray.

Clause 10. The article as in any one of clauses 1-9, wherein the soilless growth medium is positioned in contact with the seeding tray.

Clause 11. The article as in any one of clauses 1-10, wherein the soilless growth medium is configured and dimensioned to accommodate at least one root mass.

Clause 12. The article as in any one of clauses 1-11, wherein the seeding tray includes a fluorescent material.

Clause 13. The article as in any one of clauses 1-12, further includes a grid tray positioned in close proximity to the soilless growth medium.

Clause 14. The article as in any one of clauses 1-13, wherein the grid tray is configured and dimensioned to support the soilless growth medium.

Clause 15. The article as in any one of clauses 13-14, wherein the grid tray is fabricated from the group including metal, plastic, ceramic, silicone, and any combination thereof.

Clause 16. The method of planting seeds including:
positioning a plurality of seeds into a plurality of cavities in a seeding tray, wherein the at least one seed is at least partially retained by the cavity; and
a soilless growth medium below and in close proximity to the plurality of seeds, wherein a portion of the soilless growth medium is positioned below each of the plurality of seeds,
wherein the soilless growth medium is configured and dimensioned to accommodate at least one root mass.

Clause 17. The method of clause 16, wherein the cavity further defines a seed hole extending from a base of the cavity through a bottom surface of the seeding tray, and wherein the seed hole is configured and dimensioned to at least partially retain at least one seed.

Clause 18. The method as in any one of clauses 16-17, further including a grid tray positioned in close proximity to the soilless growth medium.

Clause 19. The method of claim as in any one of clauses 16-18, wherein the grid tray is configured and dimensioned to support the soilless growth medium.

Clause 20. The method as in any one of clauses 16-19, wherein the seeding tray is fabricated from a polymer.

Approximating language, as used herein throughout the specification and claims, may be applied to modify any quantitative or qualitative representation that could permissibly vary without resulting in a change in the basic function to which it is related. Accordingly, a value modified by a term such as “about” or numerical ranges is not to be limited to a specified precise value, and may include values that differ from the specified value. In at least some instances, the approximating language may correspond to the precision of an instrument for measuring the value.

While the disclosure has been described in detail in connection with only a limited number of aspects and embodiments, it should be understood that the disclosure is not limited to such aspects. Rather, the disclosure can be modified to incorporate any number of variations, alterations, substitutions, or equivalent arrangements not heretofore described, but which are commensurate with the scope of the claims. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended claims.

What is claimed is:

1. An article adapted for germinating seeds and growing plants comprising:
a seeding tray having a first surface, a second surface, and sidewalls and further defining a plurality of cavities; and
a soilless growth medium positioned with respect to the seeding tray and separable therefrom, the soilless growth medium adapted for seed germination and penetration of roots from developing plants therethrough,
wherein the plurality of cavities are configured and dimensioned to at least partially retain at least one seed.

2. The article of claim 1, wherein the plurality of cavities are defined as cubical, cylindrical, conical, frustoconical, and any combination thereof.

3. The article of claim 1, wherein the plurality of cavities are positioned in a grid-based pattern.

4. The article of claim 3, wherein the plurality of cavities are positioned about 0.5 centimeters to about 2 centimeters apart.

5. The article of claim 1, wherein the cavity is defined by at least one sidewall and a base.

6. The article of claim 5, wherein the cavity further defines a seed hole extending from the base through the second surface of the seeding tray.

7. The article of claim 6, wherein the seed hole is configured and dimensioned to at least partially retain at least one seed.

8. The article of claim 1, wherein the seeding tray is fabricated from a polymer.

9. The article of claim 1, wherein the soilless growth medium is positioned below the second surface of the seeding tray.

10. The article of claim 9, wherein the soilless growth medium is positioned in contact with the seeding tray.

11. The article of claim 9, wherein the soilless growth medium is configured and dimensioned to accommodate at least one root mass.

12. The article of claim 1, wherein the seeding tray comprises a fluorescent material.

13. The article of claim 1, further comprising a grid tray positioned in close proximity to the soilless growth medium.

14. The article of claim 13, wherein the grid tray is configured and dimensioned to support the soilless growth medium.

15. The article of claim 13, wherein the grid tray is fabricated from the group consisting of metal, plastic, ceramic, silicone, and any combination thereof.

16. The method of planting seeds comprising:
positioning a plurality of seeds into a plurality of cavities in a seeding tray, wherein the at least one seed is at least partially retained by the cavity; and
a soilless growth medium below and in close proximity to the plurality of seeds, wherein a portion of the soilless growth medium is positioned below each of the plurality of seeds,
wherein the soilless growth medium is configured and dimensioned to accommodate at least one root mass.

17. The method of claim 16, wherein the cavity further defines a seed hole extending from a base of the cavity through a bottom surface of the seeding tray, and wherein the seed hole is configured and dimensioned to at least partially retain at least one seed.

18. The method of claim 16, further comprising a grid tray positioned in close proximity to the soilless growth medium.

19. The method of claim 18, wherein the grid tray is configured and dimensioned to support the soilless growth medium.

20. The method of claim 16, wherein the seeding tray is fabricated from a polymer.
